(19) United States
(12) Patent Application Publication
(10) Pub. No.: US 2020/0223441 A1
(43) Pub. Date: Jul. 16, 2020

(54) VEHICLE, APPARATUS FOR CONTROLLING SAME, AND CONTROL METHOD THEREFOR

(71) Applicant: HONDA MOTOR CO., LTD., Tokyo (JP)

(72) Inventors: Tadahiko KANOH, Wako-shi (JP); Hiroaki HORII, Wako-shi (JP)

(21) Appl. No.: 16/828,416

(22) Filed: Mar. 24, 2020

Related U.S. Application Data
(63) Continuation of application No. PCT/JP2017/037017, filed on Oct. 12, 2017.

(51) Int. Cl. B60W 30/18; G05D 1/02; B60W 40/06

(52) U.S. Cl. CPC B60W 30/18163; B60W 40/06; G05D 1/0212

(57) ABSTRACT

A control apparatus for performing travel control of a vehicle comprises a sensor configured to detect a state around the vehicle and a travel controller configured to perform travel control for automated driving based on a detection result of the sensor. The travel controller is configured to, in a case where a predetermined condition is satisfied, select a target stop position located in a section that is adjacent to a travel path on which the vehicle is traveling, according to selection criteria, and to stop the vehicle at the target stop position, and the selection criteria include a first criterion regarding a continuous distance of the section in a direction in which the vehicle moves.

### CROSS-REFERENCE TO RELATED APPLICATION(S)

This application is a continuation of International Patent Application No. PCT/JP2017/037017 filed on Oct. 12, 2017, the entire disclosure of which is incorporated herein by reference.

### BACKGROUND OF THE INVENTION

### Field of the Invention

The present invention relates to a vehicle, an apparatus for controlling the same, and a control method therefor.

### Description of the Related Art

Japanese Patent Laid-Open No. 2007-331652 discloses a vehicle stopping apparatus that forcibly stops a vehicle in a case where a driver's consciousness decreases and the driver cannot drive normally. This vehicle stopping apparatus controls a vehicle using, as a target stop position, a position at which the width of a road shoulder is the largest. This reduces the influence on the traveling of other vehicles. It is not always the best to stop a vehicle at a position at which the width of a road shoulder is the largest as in Japanese Patent Laid-Open No. 2007-331652.

### SUMMARY OF THE INVENTION

Some aspects of the present invention provide a technique for stopping a vehicle at a position that is more natural to the driver. According to some embodiments, provided is a control apparatus for performing travel control of a vehicle, the control apparatus including: a sensor configured to detect a state around the vehicle; and a travel controller configured to perform travel control for automated driving based on a detection result of the sensor, in which the travel controller is configured to, in a case where a predetermined condition is satisfied, select a target stop position located in a section that is adjacent to a travel path on which the vehicle is traveling, according to selection criteria, and to stop the vehicle at the target stop position, and the selection criteria include a first criterion regarding a continuous distance of the section in a direction in which the vehicle moves.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings are included in, and constitute a part of, the specification, illustrate embodiments of the present invention, and are used together with the description thereof to explain the principle of the invention.

FIG. 1 is a block diagram of a vehicle according to an embodiment.

FIG. 2 is a flowchart for realizing an example of processing executed by a control apparatus of an embodiment.

FIG. 3 is a schematic diagram illustrating a vehicle stop position of an embodiment.

FIG. 4 is a schematic diagram illustrating a vehicle stop position of an embodiment.

FIG. 5 is a schematic diagram illustrating a vehicle stop position of an embodiment.

### DESCRIPTION OF THE EMBODIMENTS

Embodiments of the present invention will be described below with reference to the accompanying drawings. The same elements are given the same reference numerals in various embodiments, and a redundant description is omitted. Also, embodiments may be modified and combined as appropriate.

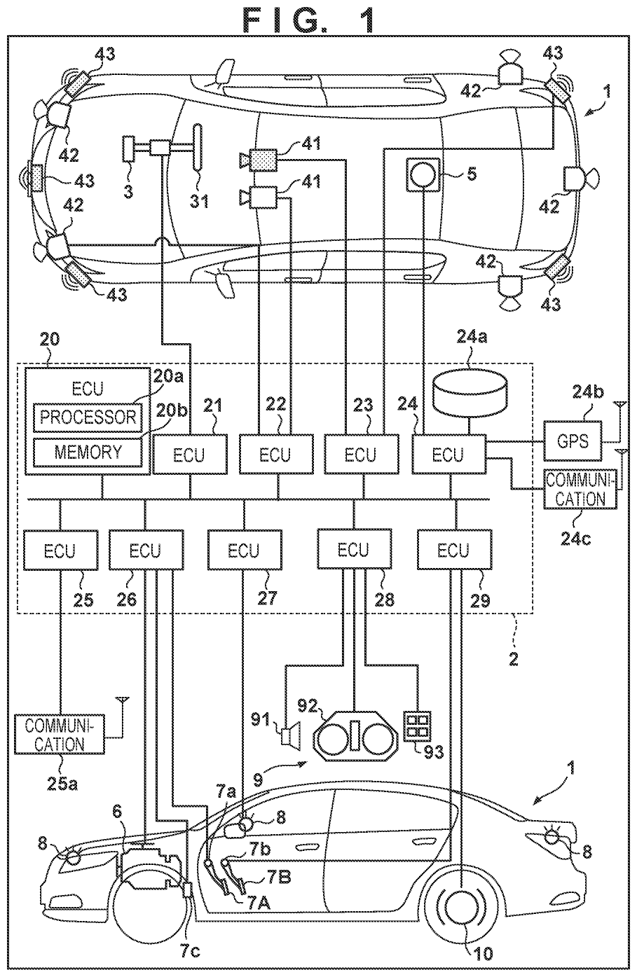

FIG. 1 is a block diagram of a control apparatus for a vehicle according to one embodiment of the present invention, and the control apparatus controls a vehicle 1. The overview of the vehicle 1 is shown in FIG. 1 with use of a plan view and a side view. The vehicle 1 is a sedan-type four-wheel passenger vehicle, as one example.

The control apparatus shown in FIG. 1 includes a control unit 2. The control unit 2 includes a plurality of ECUs 20 to 29 that are communicably connected to each other through an in-vehicle network. The ECUs each include a processor represented by a CPU, a memory such as a semiconductor memory, an interface with an external device, and the like. Programs executed by the processor, data used by the processor in processing, and the like are stored in the memory. The ECUs may also each include multiple processors, memories, interfaces, and the like. An ECU 20 includes a processor 20a and a memory 20b, for example. As a result of the processor 20a executing a command that is included in a program stored in the memory 20b, processing is executed by the ECU 20. Instead of this, the ECU 20 may include a dedicated integrated circuit for executing processing performed by the ECU 20, such as an ASIC.

Hereinafter, functions and the like of the ECUs 20 to 29 will be described. Note that the number of ECUs and their functions can be designed as appropriate, and the functions and the like may be divided or integrated more than in this embodiment.

The ECU 20 executes control related to automated driving of the vehicle 1. In automated driving, at least one of steering of the vehicle 1 and/or acceleration/deceleration is automatically controlled. In an example of control, which will be described later, both steering and acceleration/deceleration are automatically controlled.

The ECU 21 controls an electric power steering apparatus 3. The electric power steering apparatus 3 includes a mechanism for steering the front wheels according to a driving operation (steering operation) performed by a driver on a steering wheel 31. Also, the electric power steering apparatus 3 includes a motor that exerts a driving force for assisting a steering operation and automatically steering the front wheels, a sensor that detects a steering angle, and the like. If the driving state of the vehicle 1 is automated driving, the ECU 21 automatically controls the electric power steering apparatus 3 according to an instruction issued by the ECU 20, and controls the direction in which the vehicle 1 moves.

The ECUs 22 and 23 control detection units 41 to 43 are configured to detect the state of the surrounding region of the vehicle and perform information processing on detection results. The detection units 41 are cameras configured to capture images of the forward of the vehicle 1 (referred to as a “camera 41” in some cases hereinafter), and in this embodiment, two detection units 41 are provided in a front portion of the roof of the vehicle 1. A contour of a target and lane markers (white lines and the like) of lanes on a road can be extracted by analyzing the images captured by the cameras 41.

The detection units 42 are LIDARs (Light Detection and Ranging) (referred to as a “LIDAR 42” in some cases hereinafter), and detect a target in the surrounding region of the vehicle 1 and measure the distance to a target, for example. In this embodiment, five LIDARs 42 are provided, and each corner portion of a front portion of the vehicle 1 is provided with one LIDAR 42, the center of a rear portion is provided with one LIDAR 42, and each side of the rear portion is provided with one LIDAR 42. The detection units 43 are millimeter wave radars (referred to as a “radar 43” in some cases hereinafter), and detect a target in the surrounding region of the vehicle 1 and measure the distance to a target, for example. In this embodiment, five radars 43 are provided, and the center of the front portion of the vehicle 1 is provided with one radar 43, each corner portion of the front portion is provided with one radar 43, and each corner portion of the rear portion is provided with one radar 43.

The ECU 22 controls one of the cameras 41 and the LIDARs 42, and performs information processing on detection results. The ECU 23 controls the other camera 41 and the radars 43, and performs information processing on detection results. By providing two sets of apparatuses configured to detect the state of the surrounding region of the vehicle, it is possible to improve the reliability of the detection results, and by providing different types of detection units such as cameras, LIDARs, and radars, it is possible to analyze the surrounding environment of the vehicle in various ways.

The ECU 24 controls a gyro sensor 5, a GPS sensor 24b, and a communication apparatus 24c, and performs information processing on detection results or communication results. The gyro sensor 5 detects rotational motion of the vehicle 1. It is possible to determine a path of the vehicle 1 with use of the detection results of the gyro sensor 5, wheel speed, and the like. The GPS sensor 24b detects the current position of the vehicle 1. The communication apparatus 24c performs wireless communication with a server that provides map information and traffic information, and acquires these pieces of information. The ECU 24 can access a database 24a for map information constructed in a memory, and the ECU 24 searches for a route from the current position to a destination, for example. The ECU 24, the map database 24a, and the GPS sensor 24b constitute a so-called navigation apparatus.

The ECU 25 includes a communication apparatus 25a for inter-vehicle communication. The communication apparatus 25a performs wireless communication with other vehicles in the vicinity thereof, and exchanges information between vehicles.

The ECU 26 controls a power plant 6. The power plant 6 is a mechanism for outputting a driving force for rotating driving wheels of the vehicle 1, and includes an engine and a transmission, for example. The ECU 26 controls the output of the engine according to a driving operation (an accelerator operation or an acceleration operation) that is performed by a driver and detected by an operation detection sensor 7a provided in an accelerator pedal 7A, and changes the gear ratio of the transmission based on information such as the vehicle speed detected by a vehicle speed sensor 7c, for example. If the driving state of the vehicle 1 is automated driving, the ECU 26 automatically controls the power plant 6 according to an instruction issued by the ECU 20, and controls the acceleration/deceleration of the vehicle 1.

The ECU 27 controls lighting devices (head lights, tail lights, and the like) including direction indicators 8 (turn signals). In the example shown in FIG. 1, the direction indicators 8 are provided in the front portion, door mirrors, and the rear portion of the vehicle 1.

The ECU 28 controls an input/output apparatus 9. The input/output apparatus 9 outputs information to the driver, and accepts information input by the driver. A sound output apparatus 91 notifies the driver of information with use of sound. A display apparatus 92 notifies the driver of information by displaying an image. The display apparatus 92 is disposed on the surface of a driver seat, for example, and constitutes an instrument panel or the like. Note that the driver is notified using sound or a display as an example herein, but may be notified using vibrations or light. Also, the driver may be notified of information by combining two or more of sound, a display, vibrations, and light. Also, the combination thereof may be changed or the manner of a notification may be changed according to a level (a degree of urgency, for example) of information that the driver is to be notified of. An input apparatus 93 is a switch group that is disposed at a position at which the driver can operate the input apparatus 93 and issues an instruction to the vehicle 1, and may also include a sound input apparatus.

The ECU 29 controls a brake apparatus 10 and a parking brake (not shown). The brake apparatus 10 is a disk brake apparatus, for example, and is provided in each wheel of the vehicle 1, and decelerates or stops the vehicle 1 by applying resistance to rotation of the wheels. The ECU 29 controls operations of the brake apparatus 10 according to a driving operation (brake operation) of the driver that was detected by an operation detection sensor 7b provided in a brake pedal 7B, for example. If the driving state of the vehicle 1 is automated driving, the ECU 29 automatically controls the brake apparatus 10 according to an instruction issued by the ECU 20, and controls decelerating and stopping of the vehicle 1. The brake apparatus 10 and the parking brake may also be activated in order to keep the vehicle 1 stopped. Also, if the transmission of the power plant 6 includes a parking lock mechanism, the parking lock mechanism may also be activated in order to keep the vehicle 1 stopped.

Example of Control

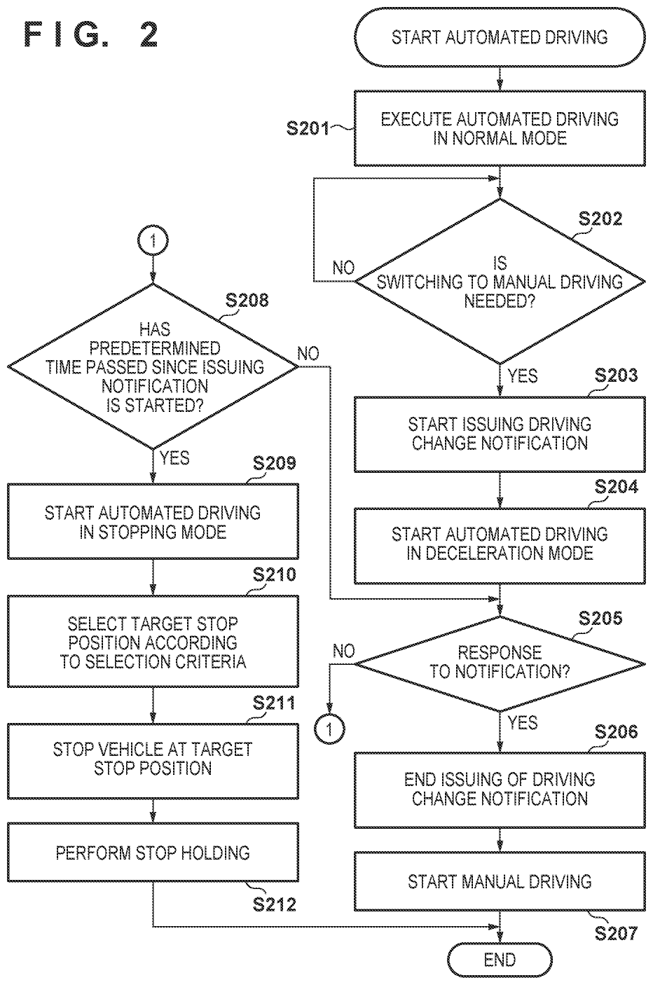

An example of control of the vehicle 1 by the ECU 20 will be described with reference to FIG. 2. The flowchart shown in FIG. 2 is started in a case where the driver of the vehicle 1 issues an instruction for starting automated driving, for example. The ECU 20 functions as an apparatus for controlling the vehicle 1. Specifically, the ECU 20 functions as a travel controller that performs travel control for automated driving based on detection results of sensors that detect the state of the surrounding region of the vehicle 1 (e.g., the detection units 41 to 43, a wheel speed sensor, a yaw rate sensor, a G sensor, and the like).

In step S201, the ECU 20 executes automated driving in a normal mode. The normal mode refers to a mode in which steering, driving, and braking are all executed as needed to reach the destination.

In step S202, the ECU 20 determines whether switching to manual driving is needed. In a case where switching is needed (“YES” in step S202), the ECU 20 advances processing to step S203, and in a case where switching is not needed (“NO” in step S202), the ECU 20 repeats step S202. The ECU 20 determines that switching to manual driving is needed, in cases where predetermined conditions are satisfied, the cases including a case where it is determined that the function of a portion of the vehicle 1 deteriorates, a case where it is difficult to continue automated driving due to a change in the surrounding traffic state, and a case where the vehicle 1 has reached near the destination set by the driver, for example.

In step S203, the ECU 20 starts issuing a driving change notification. The driving change notification refers to a notification for making, to the driver, a request for switching to manual driving. Operations of the subsequent steps S204, S205, and S208 to S212 are performed while the driving change notification being issued.

In step S204, the ECU 20 starts automated driving in a deceleration mode. The deceleration mode refers to a mode in which steering and braking are executed as needed and a response of the driver to the driving change notification is waited for. In the deceleration mode, the vehicle 1 may be naturally decelerated with use of an engine brake or a regenerative brake, or braking may be performed utilizing a braking actuator (e.g., a friction brake). Also, the ECU 20 may increase the strength of a deceleration regeneration (e.g., by increasing the amount of regeneration), or may increase the strength of the engine brake (e.g., by reducing the gear ratio to a low ratio) even in the case of natural deceleration.

In step S205, the ECU 20 determines whether the driver has made a response to the driving change notification. In a case where the driver has made a response (“YES” in step S205), the ECU 20 advances processing to step S206, and in a case where the driver has not made a response (“NO” in step S205), the ECU 20 advances processing to step S208. The driver can make an indication for changing to manual driving with use of the input apparatus 93, for example. Instead of this, the driver may make an indication of their intention with use of steering detected by a steering torque sensor, holding of the steering wheel 31 detected by a holding sensor, the line-of-sight direction of the driver detected by a driver monitor camera, for example.

In step S206, the ECU 20 stop issuing the driving change notification. In step S207, the ECU 20 ends automated driving in the deceleration mode that is being executed, and starts manual driving. In manual driving, the ECUs of the vehicle 1 each control traveling of the vehicle 1 according to a driving operation of the driver. There is a possibility that performance or the like of the ECU 20 will decrease, and thus the ECU 28 may output, on the display apparatus 92, a message or the like for promoting to bring the vehicle 1 to a maintenance shop.

In step S208, the ECU 20 determines whether a predetermined time (e.g., a time according to automated driving levels of the vehicle 1, such as 4 seconds or 15 seconds) has passed from when issuing of the driving change notification is started. In a case where the predetermined time has passed (“YES” in step S208), the ECU 20 advances processing to step S209, and in a case where the predetermined time has not passed (“NO” in step S208), the ECU 20 returns processing to step S205, and repeats the processing from step S205 onward.

In step S209, the ECU 20 ends automated driving in the deceleration mode that is being executed and starts automated driving in a stopping mode. The stopping mode refers to a mode for stopping the vehicle 1 at a safety position or decelerating the vehicle 1 to a speed that is lower than a deceleration end speed in the deceleration mode. Specifically, the ECU 20 searches for a position at which the vehicle 1 can be stopped, while actively decelerating the vehicle 1 to a speed that is lower than the deceleration end speed in the deceleration mode. In a case where the ECU 20 found a stoppable position, the ECU 20 stops the vehicle 1 at this position, and in a case where the ECU 20 cannot find a stoppable position, the ECU 20 searches for a stoppable position while running the vehicle 1 at an excessively low speed (e.g., a creep speed). Operations of the subsequent steps S210 to S212 are performed while the stopping mode is being executed.

In step S210, the ECU 20 selects a target stop position according to selection criteria. The target stop position refers to a position serving as a target for stopping the vehicle 1. The selection criteria will be described later. In step S211, the ECU 20 stops the vehicle 1 at the selected target stop position.

In step S212, the ECU 20 determines to stop the vehicle 1 from the detection results of the wheel speed sensors, and if it is determined that the vehicle has stopped, the ECU 20 instructs the ECU 29 to activate the electric parking lock apparatus, and performs stop holding control for keeping the vehicle 1 stopped. In a case where automated driving is performed in the stopping mode, a notification indicating that stopping is being performed may be issued to other vehicles in the vicinity thereof with use of a hazard lamp or another display apparatus, or other vehicles or other terminal devices may be notified thereof with use of a communication apparatus. The ECU 20 may perform deceleration control according to the presence or absence of other vehicles following behind the vehicle 1 while automated driving is executed in the stopping mode. The ECU 20 may make the degree of deceleration for the case where there are no vehicles following behind the vehicle 1 stronger than the degree of deceleration for the case where there is a vehicle following behind the vehicle 1, for example.

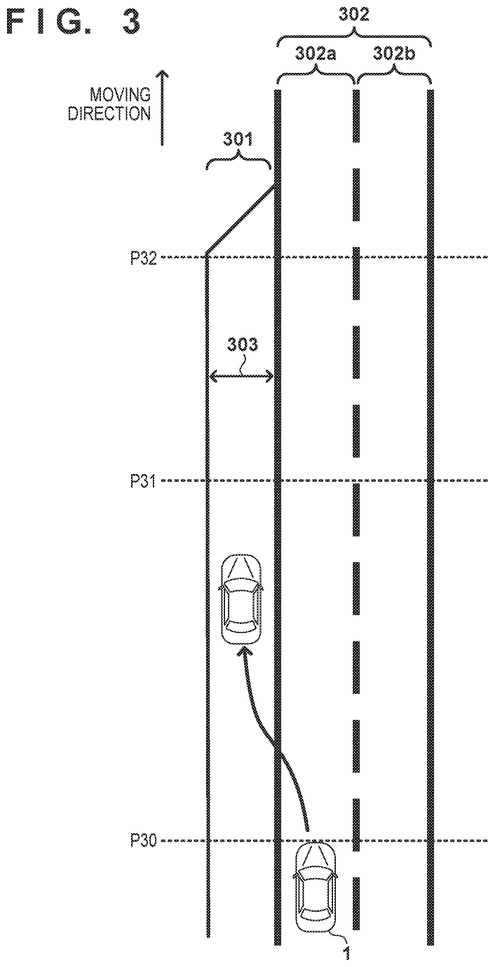

The selection criteria used in step 5210 described above will be described with reference to FIGS. 3 to 5. In the description of FIGS. 3 to 5, it is presumed that the vehicle 1 is traveling on a left-hand traffic road. The road on which the vehicle 1 is traveling is constituted by a travel path 302 and a section 301 (e.g., a roadside belt and a road shoulder) that is adjacent to the travel path 302. The travel path 302 is divided into two lanes 302a and 302b. The width of the section 301 is referred to as a width 303. The width 303 of the section 301 refers to the length of the section 301 in a direction orthogonal to the direction in which the vehicle 1 moves. The width 303 may be measured by a sensor of the vehicle 1, or may be determined based on map information. In step 5211 described above, the ECU 20 moves the vehicle 1 to the section 301 before stopping the vehicle 1 there. In order to move the vehicle 1 to the section 301, the ECU 20 may change a lane in the travel path 302. Stopping the vehicle 1 in the section 301 includes a case where the entire vehicle 1 is located on the section 301, and a case where only a portion of the vehicle 1 is located on the section 301 and the other portion thereof is located on the travel path 302.

The selection criteria may include criteria regarding the continuous distance of the section 301 in the moving direction of the vehicle 1. Hereinafter, the criteria will be referred to as section distance criteria. The section distance criteria will be described with reference to FIG. 3. The current position of the vehicle 1 is denoted by P30.

When the vehicle 1 stops in the section 301 and then restarts again to return to the travel path 302, the vehicle 1 can easily return thereto as a result of the vehicle 1 sufficiently accelerating in the section 301. In view of this, the ECU 20 selects, as the target stop position, a position at which the section 301 has a sufficient continuous distance in the moving direction of the vehicle 1, according to the section distance criteria.

In order for the vehicle 1 to travel in the section 301, the section 301 needs to have a somewhat wide width 303. In view of this, the section distance criteria may include a criterion in which a portion of the section 301 that has a predetermined width or more continues from the target stop position in the moving direction of the vehicle 1 by a threshold or more. It is presumed that, in the example shown in FIG. 3, the width 303 of the section 301 is the predetermined width or more, from the position P30 to a position P32, and when the vehicle 1 passes the position P32, the width 303 of the section 301 is less than the predetermined width. In this case, the ECU 20 stops the vehicle 1 before the position P31 located only the threshold in front of the position P32, that is, at a position located from the position P30 to the position P31. The vehicle 1 stopped at this position can sufficiently accelerate because a portion of the section 301 that has the predetermined width or more continues from the target stop position in the moving direction of the vehicle 1 by the threshold or more.

The predetermined width of the section 301 used in the section distance criteria may be preset according to the vehicle width of the vehicle 1 and stored in the ECU 20. The predetermined width may be 1.5 times the vehicle width of the vehicle 1, for example. Also, the threshold used for the section distance criteria may be preset and stored in the ECU 20. The threshold may be 100 m, for example. Also, the ECU 20 may be capable of setting any threshold. The ECU 20 may set the threshold according to at least any of the gradient of the travel path 302 and/or the curvature of the travel path 302. The threshold for the case where the travel path 302 is flat and straight is referred to as a standard value.

In a case where the travel path 302 is uphill, for example, it is difficult for the vehicle 1 to accelerate, compared to the case where the travel path 302 is flat, and thus the ECU 20 sets the threshold to a value that is larger than the standard value. On the other hand, in a case where the travel path 302 is downhill, for example, it is easy for the vehicle 1 to accelerate, compared to the case where the travel path 302 is flat, and thus the ECU 20 sets the threshold to a value that is smaller than the standard value. Also, the ECU 20 may increase the amount of change in the threshold as the degree of an inclination increases.

In a case where the travel path 302 has a large curvature, it is difficult to detect other vehicles because the vehicle 1 that has stopped in the section 301 has low visibility of the rear side (the direction opposite to the moving direction). In a case where visibility is low at the stop position, there is a possibility that the vehicle 1 will restart traveling, and then other vehicles will be able to be detected while the vehicle 1 is traveling in the section 301. In such a case, the ECU 20 sets the threshold to a value that is larger than the standard value such that the timing of merging can be obtained after the other vehicles are detected. Accordingly, the vehicle 1 can easily return to the travel path 302 while checking the movement of vehicles following behind the vehicle 1. The ECU 20 may set the threshold based on the curvature of the travel path 302 on the rear side of the target stop position. Also, the ECU 20 may increase the amount of change in the threshold as the curvature of the travel path 302 increases.

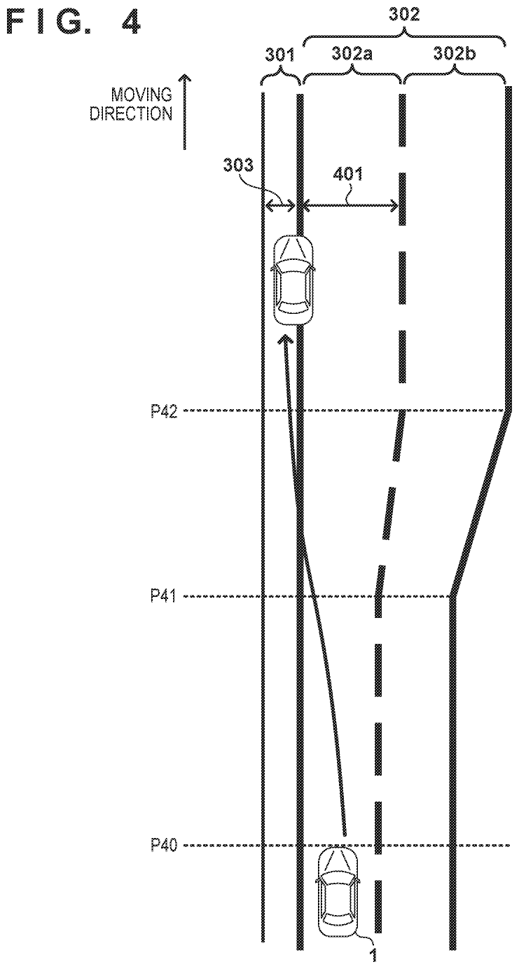

The selection criteria may include criteria regarding the width of the lane 302a that is adjacent to the section 301. Hereinafter, these criteria will be referred to as lane width criteria. The lane width criteria will be described with reference to FIG. 4. The current position of the vehicle 1 is denoted by P40. Also, the width of the lane 302a that is adjacent to the section 301 is referred to as a width 401. The width 401 of the lane 302a refers to the length of the lane 302a in a direction orthogonal to the moving direction of the vehicle 1.

In a case where the width 303 of the section 301 is narrow, there are cases where the vehicle 1 does not fit in the section 301 and protrudes into the lane 302a. In this case, stopping the vehicle 1 at a position where the width 401 of the lane 302a is wide reduces the influence on the other vehicles. In view of this, in one example, the ECU 20 selects, as the target stop position, a position satisfying that the width of the lane 302a adjacent to the section 301 is more than or equal to the threshold.

It is presumed that the width 401 of the lane 302a widens from a position P41 to a position P42 in FIG. 4, for example. Also, it is presumed that the width 401 of the lane 302a is more than or equal to the threshold from the position P42 onward. In this case, the ECU 20 selects, as the target stop position, a position located after the position P42. The threshold used for the lane width criteria may be preset and stored in the ECU 20. The threshold may be 1.5 times the vehicle width of the vehicle 1, for example.

In an example other than the above-described example, the ECU 20 selects, as the target stop position, a position satisfying that a total value of the width of the lane 302a adjacent to the section 301 and the width 303 of the section 301 is more than or equal to the threshold. This selection method is effective for a case where the width 303 of the section 301 changes depending on positions. This threshold may be 2.5 times the vehicle width of the vehicle 1.

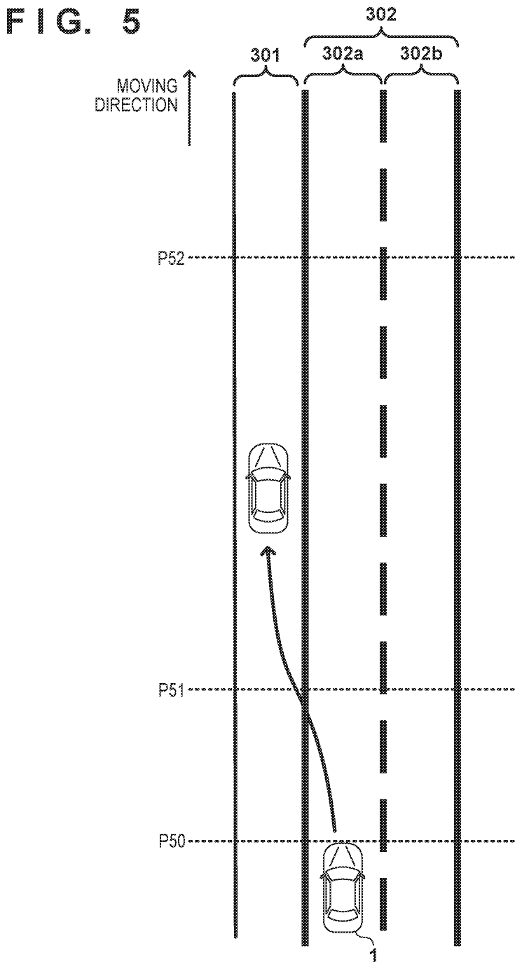

The selection criteria may include criteria regarding the distance from the position of the vehicle 1 at the time when in step S202, it is determined that a predetermined condition is satisfied, or at the time when the vehicle 1 starts decelerating in step S204. Hereinafter, these criteria will be referred to as travel distance criteria. The travel distance criteria will be described with reference to FIG. 5. The position of the vehicle 1 at the time when in step S202, it is determined that the predetermined condition is satisfied, or at the time when the vehicle 1 starts decelerating in step S204 is denoted by P50.

If the distance from the position P50 to the target stop position is excessively short, the vehicle 1 needs to rapidly decelerate, which places a burden on the driver of the vehicle 1. Also, in a case where there is a vehicle following behind the vehicle 1, there is a risk that as a result of the vehicle 1 rapidly decelerating, the vehicle 1 will excessively come close to the vehicle following behind the vehicle 1. On the other hand, if the distance from the position P50 to the target stop position is excessively long, it takes time until the vehicle 1 stops, and there is a possibility that the driver will feel uneasy. In view of this, the ECU 20 selects, as the target stop position, a position where the distance from the position P50 is the lower limit threshold to the upper limit threshold inclusive. In the example shown in FIG. 5, the ECU 20 selects, as the target stop position, a position located from the position P51 to the position P52. The ECU 20 may determine the target stop position based on the presence or absence of other vehicles following behind the vehicle 1, the inter-vehicular distance to a vehicle following behind the vehicle 1, and the like.

The lower limit threshold and the upper limit threshold used for the travel distance criteria may be preset and stored in the ECU 20. The lower limit threshold may be 50 m, and the upper limit threshold may be 500 m, for example. Also, the ECU 20 may be capable of setting the lower limit threshold and the upper limit threshold. The ECU 20 may set any lower limit threshold and any upper limit threshold according to at least any of the traveling state of the vehicle 1, the gradient of the travel path 302, the curvature of the travel path 302, and/or the state of the driver of the vehicle 1. The state of the driver of the vehicle 1 may include the line-of-sight direction of the driver, the steering wheel holding state, and the like, for example. The threshold for the case where the travel path 302 is flat and straight is referred to as a standard value.

The speed of the vehicle 1 is handled as the traveling state of the vehicle 1, for example. In a case where the speed of the vehicle 1 is high, it takes more time until the vehicle 1 stops, compared to the case where the speed of the vehicle 1 is low, and thus the ECU 20 sets the lower limit threshold and the upper limit threshold for the case where the speed of the vehicle 1 is high to values that are larger than the thresholds for the case where the speed of the vehicle 1 is low. In a case where the travel path 302 is uphill, it is easy for the vehicle 1 to decelerate, compared to the case where the travel path 302 is flat, and thus the ECU 20 sets the lower limit threshold and the upper limit threshold to values that are smaller than the standard value. On the other hand, in a case where the travel path 302 is downhill, it is difficult for the vehicle 1 to decelerate, compared to the case where the travel path 302 is flat, and thus the ECU 20 sets the lower limit threshold and the upper limit threshold to values that are larger than the standard value. The ECU 20 may increase the amount of change in the threshold as the degree of an inclination increases. In a case where the travel path 302 has a large curvature, visibility from the vehicle 1 is low, and thus the ECU 20 sets the upper limit threshold to a value that is larger than the standard value. The ECU 20 sets the lower limit threshold and the upper limit threshold for the case where the line-of-sight of the driver is far away larger than the lower limit threshold and the upper limit threshold for the case where the line-of-sight of the driver is close. It is conceivable that the line-of-sight direction of the driver indicates the driver's desired stop position, and thus it is possible to select, as the target stop position, a position corresponding to the driver's intention. Also, the ECU 20 may change the lower limit threshold and the upper limit threshold based on the location of an emergency telephone.

Three criteria, namely, the section distance standard, the lane width criteria, and the travel distance criteria, were described as the selection criteria above. The selection criteria may include only one, any two, or all of these three criteria. Also, the selection criteria may include criteria other than these three criteria. In a case where the selection criteria include two or more criteria, the ECU 20 may set priorities to the respective criteria, for example. It is presumed that the priority decreases in the order of the section distance criteria, the lane width criteria, and the travel distance criteria, for example. In this case, the ECU 20 first selects candidates for the target stop position according to the section distance criteria. Then, the ECU 20 selects the target stop position that satisfies the lane width criteria, from the selected candidates. Also, the ECU 20 selects a position that satisfies the travel distance criteria, from the remaining candidates. Here, if there is no position that satisfies the travel distance criteria, the ECU 20 selects the target stop position from positions that satisfy the section distance criteria and the lane width criteria.

Although control for automating all of driving, braking, and steering has been described as automated driving control executed by the ECU 20 in an automated driving mode in the above-described embodiment, the automated driving control need only to control at least one of driving, braking, and/or steering, independent of a driving operation of the driver. Performing control independent of a driving operation of the driver may include performing control without a driver's input to an operator represented by a steering wheel or a pedal, or it can be said that the intention of the driver to drive a vehicle is not required. Thus, the automated driving control encompasses a state in which the driver is obliged to monitor the surroundings and at least one of driving, braking and/or steering of the vehicle 1 is controlled according to information regarding the surrounding environment of the vehicle 1, a state in which the driver is obliged to monitor the surroundings and at least one of driving and/or braking of the vehicle 1 is controlled according to information regarding the surrounding environment of the vehicle 1, and a state in which the driver is not obliged to monitor the surroundings and all of driving, braking and steering of the vehicle 1 are controlled according to information regarding the surrounding environment of the vehicle 1. Also, the automated driving control may enable transition to each of these control stages. Also, a configuration may be adopted in which a sensor for detecting information regarding the state of the driver (biological information such as the heart rate, information such as facial expressions and pupil conditions) is provided, and automated driving control is executed or inhibited according to the detection results of this sensor.

### Summary of Embodiments

### Configuration 1

A control apparatus for performing travel control of a vehicle (1), the control apparatus including:

a sensor (41 to 43) configured to detect a state around the vehicle; and

a travel controller (20) configured to perform travel control for automated driving based on a detection result of the sensor,

in which the travel controller is configured to, in a case where a predetermined condition is satisfied, select a target stop position located in a section (301) that is adjacent to a travel path (302) on which the vehicle is traveling, according to selection criteria, and to stop the vehicle at the target stop position, and

the selection criteria include a first criterion regarding a continuous distance of the section in a direction in which the vehicle moves.

According to this configuration, the vehicle can easily return to the travel path after the vehicle is stopped.

### Configuration 2

The control apparatus according to Configuration 1, wherein the first criterion includes that a portion of the section that has a predetermined width or more continues from the target stop position in the moving direction of the vehicle by a first threshold or more.

According to this configuration, the vehicle can sufficiently accelerate in the section before returning to the travel path.

### Configuration 3

The control apparatus according to Configuration 2, wherein the travel controller sets the first threshold according to at least any of a gradient of the travel path and/or a curvature of the travel path.

According to this configuration, it is possible to set a threshold according to a situation.

### Configuration 4

The control apparatus according to any one of Configurations 1 to 3, wherein the selection criteria further include a second criterion regarding a width of a lane (302a) that is adjacent to the section.

According to this configuration, it is possible to reduce the influence on other vehicles while the vehicle is stopped.

### Configuration 5

The control apparatus according to Configuration 4, wherein the second criterion includes that the width of the lane that is adjacent to the section is more than or equal to a second threshold, or that a total value of the width of the lane that is adjacent to the section and a width of the section is more than or equal to a third threshold.

According to this configuration, it is possible to reduce the influence on other vehicles while the vehicle is stopped.

### Configuration 6

The control apparatus according to any one of Configurations 1 to 5, wherein the selection criteria further include a third criterion regarding a distance from a position of the vehicle at a time when it is determined that the predetermined condition is satisfied, or at a time when the vehicle starts decelerating.

According to this configuration, it is possible to stop the vehicle at a position that is more natural to the driver.

### Configuration 7

The control apparatus according to Configuration 6, wherein the third criterion includes that the distance from the position is less than or equal to a fourth threshold.

According to this configuration, it is possible to reduce the driver's anxiety.

### Configuration 8

The control apparatus according to Configuration 7, wherein the travel controller sets the fourth threshold according to at least any of a traveling state of the vehicle, a gradient of the travel path, a curvature of the travel path, and/or a state of a driver of the vehicle.

According to this configuration, it is possible to set a threshold according to a situation.

### Configuration 9

A control apparatus for performing travel control of a vehicle (1), the control apparatus including:

a sensor (41 to 43) configured to detect a state around the vehicle; and

a travel controller (20) configured to perform travel control for automated driving based on a detection result of the sensor,

in which the travel controller is configured to, in a case where a predetermined condition is satisfied, select a target stop position located in a section (301) that is adjacent to a travel path (302) on which the vehicle is traveling, according to selection criteria, and to stop the vehicle at the target stop position, and

the selection criteria include a criterion regarding a width of a lane that is adjacent to the section.

According to this configuration, it is possible to reduce the influence on other vehicles while the vehicle is stopped.

### Configuration 10

A control apparatus for performing travel control of a vehicle (1), the control apparatus including:

a sensor (41 to 43) configured to detect a state around the vehicle; and

a travel controller (20) configured to perform travel control for automated driving based on a detection result of the sensor,

in which the travel controller is configured to, in a case where a predetermined condition is satisfied, select a target stop position located in a section (301) that is adjacent to a travel path (302) on which the vehicle is traveling, according to selection criteria, and to stop the vehicle at the target stop position, and

the selection criteria include a criterion regarding a distance from a position of the vehicle at a time when it is determined that the predetermined condition is satisfied, or at a time when the vehicle starts decelerating.

According to this configuration, it is possible to stop the vehicle at a position that is more natural to the driver.

### Configuration 11

A vehicle, including:

the control apparatus according to any one of Configurations 1 to 10; and
an actuator group controlled by the travel controller of the control apparatus.

According to this configuration, it is possible to provide a vehicle that can be stopped at a position that is more natural to the driver.

### Configuration 12

A method for controlling a vehicle that includes a sensor (41 to 43) configured to detect a state around the self-vehicle (1) and to perform travel control for automated driving based on a detection result of the sensor, the method including

a step of, in a case where a predetermined condition is satisfied, selecting a target stop position located in a section (301) that is adjacent to a travel path (302) on which the vehicle is traveling, according to selection criteria, and stopping the vehicle at the target stop position,

in which the selection criteria include at least any of
a first criterion regarding a continuous distance of the section in a direction in which the vehicle moves,
a second criterion regarding a width of a lane (302a) that is adjacent to the section, and/or
a third criterion regarding a distance from a position of the vehicle at a time when it is determined that the predetermined condition is satisfied, or at a time when the vehicle starts decelerating.

According to this configuration, it is possible to stop the vehicle at a position that is more natural to the driver.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A control apparatus for performing travel control of a vehicle, the control apparatus comprising:
a sensor configured to detect a state around the vehicle; and
a travel controller configured to perform travel control for automated driving based on a detection result of the sensor,
wherein the travel controller is configured to, in a case where a predetermined condition is satisfied, select a target stop position located in a section that is adjacent to a travel path on which the vehicle is traveling, according to selection criteria, and to stop the vehicle at the target stop position, and
the selection criteria include a first criterion regarding a continuous distance of the section in a direction in which the vehicle moves.

2. The control apparatus according to claim 1, wherein
the first criterion includes that a portion of the section that has a predetermined width or more continues from the target stop position in the moving direction of the vehicle by a first threshold or more.

3. The control apparatus according to claim 2, wherein
the travel controller sets the first threshold according to at least any of a gradient of the travel path and/or a curvature of the travel path.

4. The control apparatus according to claim 1, wherein
the selection criteria further include a second criterion regarding a width of a lane that is adjacent to the section.

5. The control apparatus according to claim 4, wherein
the second criterion includes that the width of the lane that is adjacent to the section is more than or equal to a second threshold, or that a total value of the width of the lane that is adjacent to the section and a width of the section is more than or equal to a third threshold.

6. The control apparatus according to claim 1, wherein
the selection criteria further include a third criterion regarding a distance from a position of the vehicle at a time when it is determined that the predetermined condition is satisfied, or at a time when the vehicle starts decelerating.

7. The control apparatus according to claim 6, wherein
the third criterion includes that the distance from the position is less than or equal to a fourth threshold.

8. The control apparatus according to claim 7, wherein
the travel controller sets the fourth threshold according to at least any of a traveling state of the vehicle, a gradient of the travel path, a curvature of the travel path, and/or a state of a driver of the vehicle.

9. A control apparatus for performing travel control of a vehicle, the control apparatus comprising:
a sensor configured to detect a state around the vehicle; and
a travel controller configured to perform travel control for automated driving based on a detection result of the sensor,
wherein the travel controller is configured to, in a case where a predetermined condition is satisfied, select a target stop position located in a section that is adjacent to a travel path on which the vehicle is traveling, according to selection criteria, and to stop the vehicle at the target stop position, and
the selection criteria include a criterion regarding a width of a lane that is adjacent to the section.

10. A control apparatus for performing travel control of a vehicle, the control apparatus comprising:
a sensor configured to detect a state around the vehicle; and
a travel controller configured to perform travel control for automated driving based on a detection result of the sensor,
wherein the travel controller is configured to, in a case where a predetermined condition is satisfied, select a target stop position located in a section that is adjacent to a travel path on which the vehicle is traveling, according to selection criteria, and to stop the vehicle at the target stop position, and
the selection criteria include a criterion regarding a distance from a position of the vehicle at a time when it is determined that the predetermined condition is satisfied, or at a time when the vehicle starts decelerating.

11. A vehicle, comprising:
the control apparatus according to claim 1; and
an actuator group controlled by the travel controller of the control apparatus.

12. A vehicle, comprising:
the control apparatus according to claim 9; and
an actuator group controlled by the travel controller of the control apparatus.

13. A vehicle, comprising:
the control apparatus according to claim 10; and
an actuator group controlled by the travel controller of the control apparatus.

14. A method for controlling a vehicle that includes a sensor configured to detect a state around the self-vehicle and to perform travel control for automated driving based on a detection result of the sensor, the method comprising
a step of, in a case where a predetermined condition is satisfied, selecting a target stop position located in a section that is adjacent to a travel path on which the vehicle is traveling, according to selection criteria, and stopping the vehicle at the target stop position,
wherein the selection criteria include at least any of
a first criterion regarding a continuous distance of the section in a direction in which the vehicle moves,
a second criterion regarding a width of a lane that is adjacent to the section, and/or
a third criterion regarding a distance from a position of the vehicle at a time when it is determined that the predetermined condition is satisfied, or at a time when the vehicle starts decelerating.
